(19) United States
(12) Patent Application Publication
(10) Pub. No.: US 2009/0078919 A1
(43) Pub. Date: Mar. 26, 2009

(54) Support device

(76) Inventor: Yi-Chun Tseng, Taichung (TW)

Correspondence Address: PRO-TECHTOR INTERNATIONAL SERVICES, 20775 NORADA CT., SARATOGA, CA, 95070, US

(21) Appl. No.: 11/903,778

(22) Filed: Sep. 24, 2007

(51) Int. Cl. B66F 1/02

(52) U.S. Cl. 254/105

(57) ABSTRACT

A support device comprises a base including a receiving portion disposed on the top of one side thereof for receiving a post which allows to hold a heavy object, a stopping mechanism defined between the post and the base and including teeth arranged on one side of the post, the base also including a rotatable engaging member affixed thereon for correspondingly engaging with the teeth, wherein the base further includes a pedal fitted in another side thereof so as to move vertically. Besides, between the pedal and the post is defined with a transmitting mechanism including a rotatable wheel pivotally disposed on the base and having a chain, one end of which is coupled to the bottom of the post, and another end of which is connected to the pedal, mounted thereon, such that while the pedal moves vertically, the post is urged to move vertically as well, thereby obtaining a quick and safe operation.

### BACKGROUND OF THE INVENTION

1. Field of the Invention

The present invention relates to a support device that may quickly move the support upward to a proper height by way of a transmitting mechanism between the pedal and the support, and may obtain a quick and safe operation by using the stopping mechanism to position the support for holding a heavy object.

2. Description of the Prior Arts

A lifter, such as a jack or a lift, may be applied in different conditions, for example, the maintenance of vehicles, the replacement of machine tools and the like. In general operation, as the lifer is raised to a proper height, the user may go ahead the maintenance process below the held object, however, if the lifter is suddenly broken to fall down, the user will become injured. Accordingly, how to avoid the operational danger is a first priority.

As illustrated in FIGS. 1 and 2, a support 10 for use in a prior art lifter comprises a base 11 including a receiving portion 12 provided on the top thereof and having a retaining recess 121 formed therethrough for receiving a post 13. The post 13 includes a holding segment 131 mounted on the top thereof for holding a heavy object, and between the post 13 and the receiving portion 12 of the base 11=defined with a stopping mechanism including teeth 132 arranged on one side of the support 13, and including a rotatable lever 14 axially attached on the receiving portion 12 and having an engaging member 16 couplingly affixed thereon for engaging with the teeth 132 by means of a bolt element 15. As shown in FIG. 3, in operation, the lifter (not shown) is applied to raise a heavy object 20 up to a proper height, and the support 10 is placed beneath the heavy object 20. Due to the raised height of the heavy object 20 is not certain, the user has to push the lever 14 upwardly for actuating the upward rotation of the engaging member 16, and then the engaging member 16 disengages from the teeth 132 of the post 13 for opening the stopping mechanism. Thereafter, the user further lifts the post 13 upward by hands so that the post 13 raises to contact the bottom of the heavy object 20. With reference to FIG. 4, while releasing the lever 14, the lever 14 rotates downward and actuates the engaging member 16 to rotate downwardly for engaging with the teeth 132 of the post 13, thereby closing the stopping mechanism so that the post 13 positions at a proper height; in the meantime, the lifter is removed and then the support 10 is used to hold the heavy object 20.

Nevertheless, as operating the support 13 to move upwardly, the user has to push the lever 14 upward with one hand and to lift the post 13 upward by another hand so that the support 13 may contact the bottom of the heavy object 20, thus consuming the user's force and having a potential operational danger.

The present invention has arisen to mitigate and/or obviate the afore-described disadvantages.

### SUMMARY OF THE INVENTION

The primary object of the present invention is to provide a support device that may allow the post to move upward quickly.

Another object of the present invention is to provide a support device that may achieve a safe and labor saving purpose.

In accordance with one aspect of the present invention, there is provided a support device comprising a base including a receiving portion disposed on the top of one side thereof for receiving a post which allows to hold a heavy object, a stopping mechanism defined between the post and the base and including teeth arranged on one side of the post, the base also including a rotatable engaging member affixed thereon for correspondingly engaging with the teeth, wherein the base further includes a pedal fitted in another side thereof so as to move vertically. Besides, between the pedal and the post is defined with a transmitting mechanism including a rotatable wheel pivotally disposed on the base and having a chain, one end of which is coupled to the bottom of the post, and another end of which is connected to the pedal, mounted thereon, such that while the pedal moves vertically, the post is urged to move vertically as well.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective diagram illustrating the assembly of a prior art support;

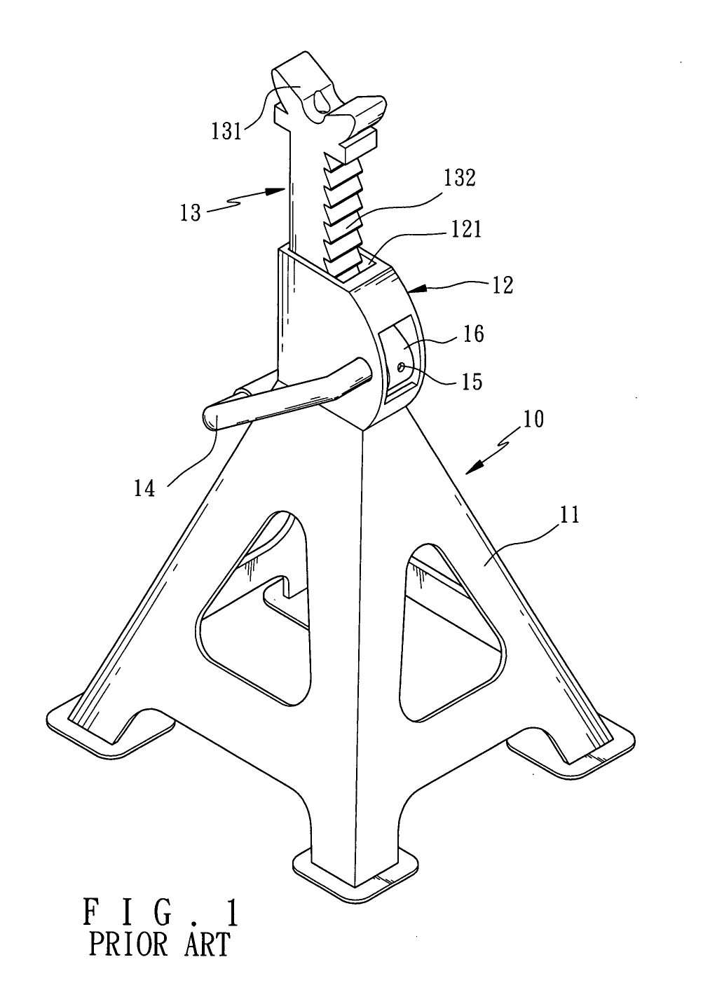

FIG. 2 is a cross sectional diagram illustrating the assembly of the prior art support;

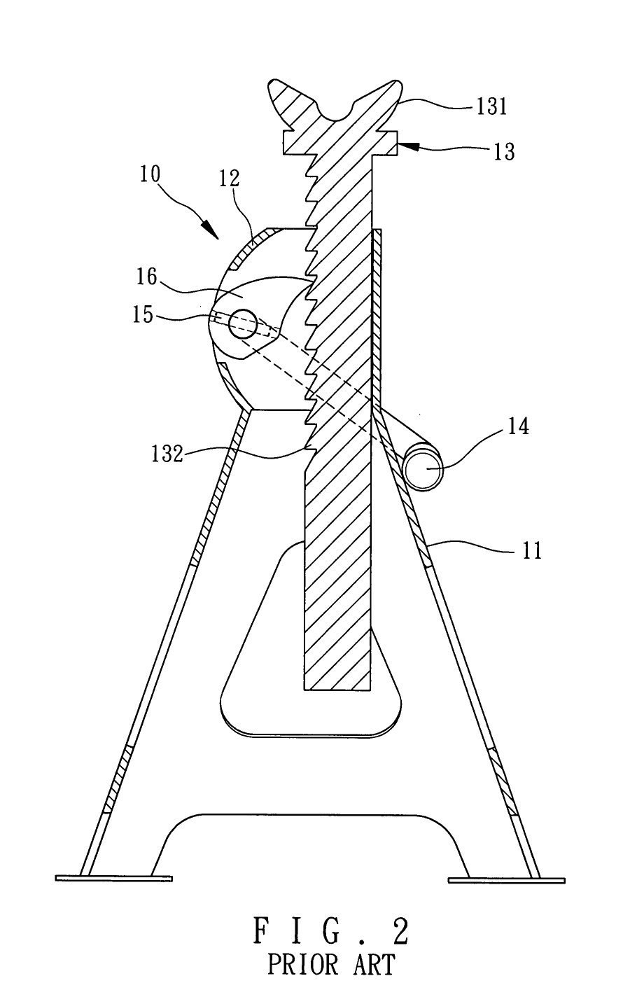

FIG. 3 is a cross sectional diagram illustrating the operation of the prior art support;

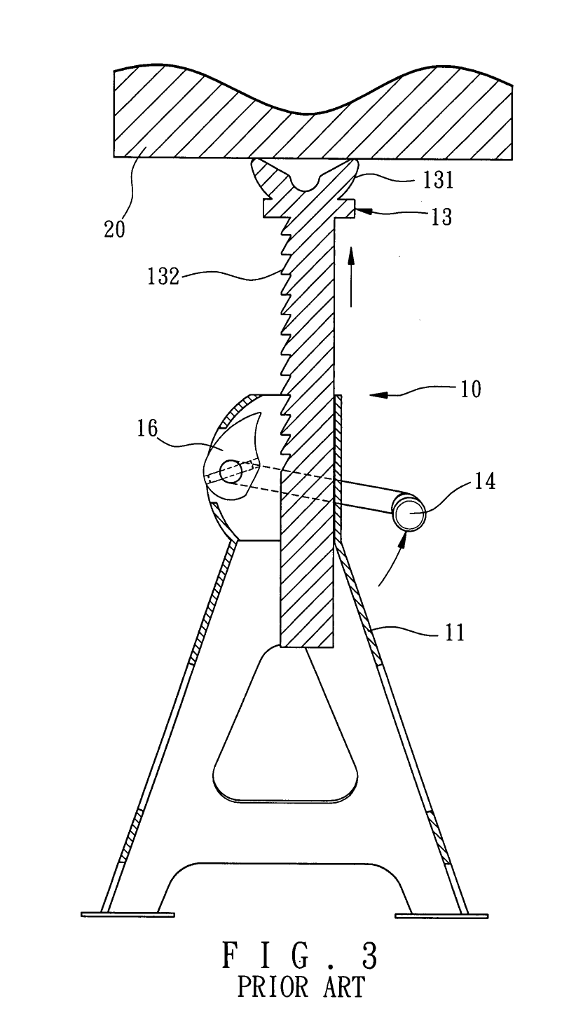

FIG. 4 is another cross sectional diagram illustrating the operation of the prior art support;

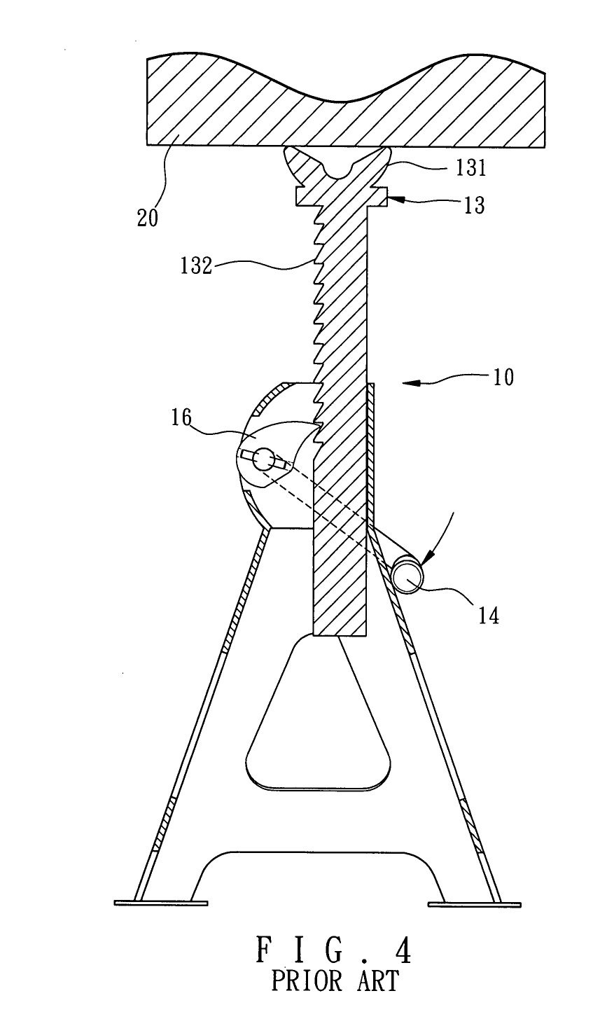

FIG. 5 is a perspective diagram illustrating the exploded components of a support device according to the present invention;

FIG. 6 is a perspective diagram illustrating the assembly of the support device according to the present invention;

FIG. 7 is a cross sectional diagram illustrating the assembly of the support device according to the present invention;

FIG. 8 is a cross sectional diagram illustrating the operation of the support device according to the present invention;

FIG. 9 is another cross sectional diagram illustrating the operation of the support device according to the present invention;

FIG. 10 is a further cross sectional diagram illustrating the operation of the support device according to the present invention;

FIG. 11 is still a further cross sectional diagram illustrating the operation of the support device according to the present invention;

FIG. 12 is another cross sectional diagram illustrating the operation of the support device according to the present invention.

### DETAILED DESCRIPTION OF THE PREFERRED EMBODIMENT

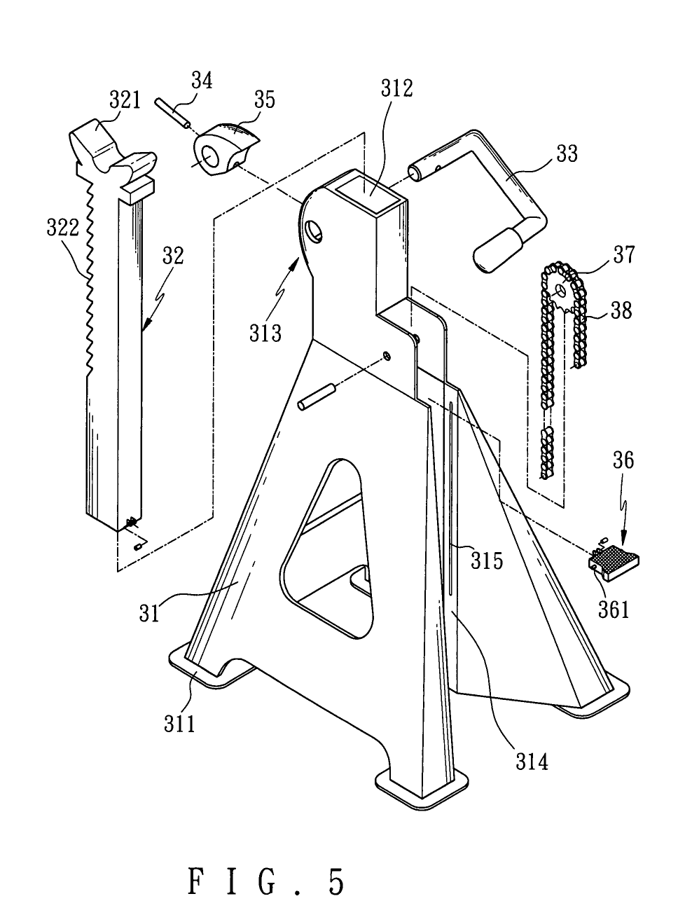

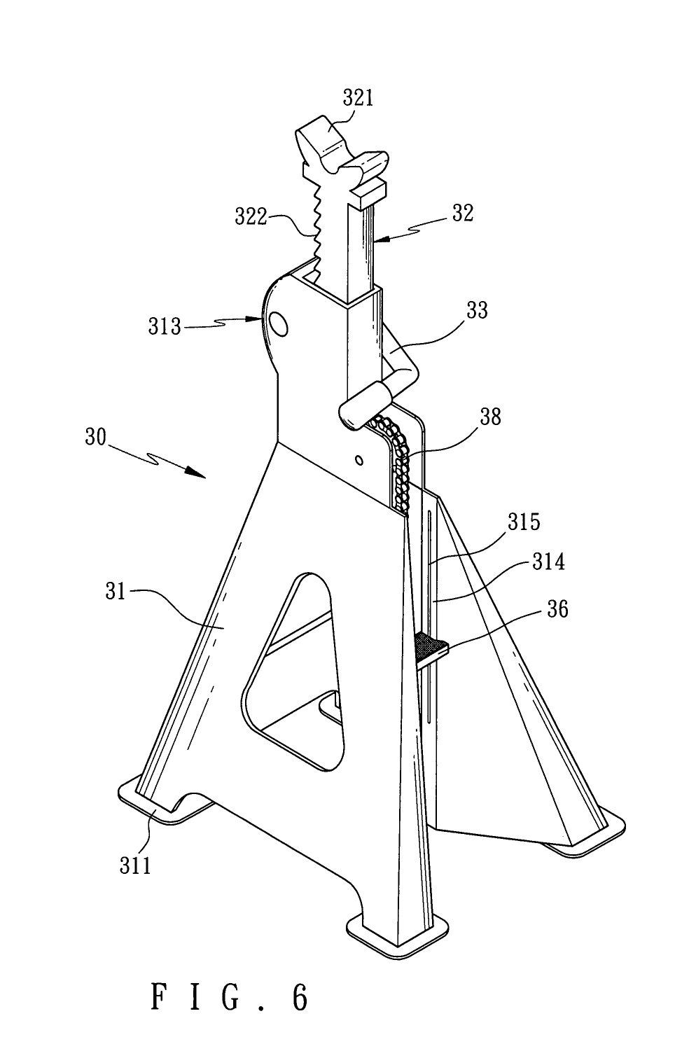

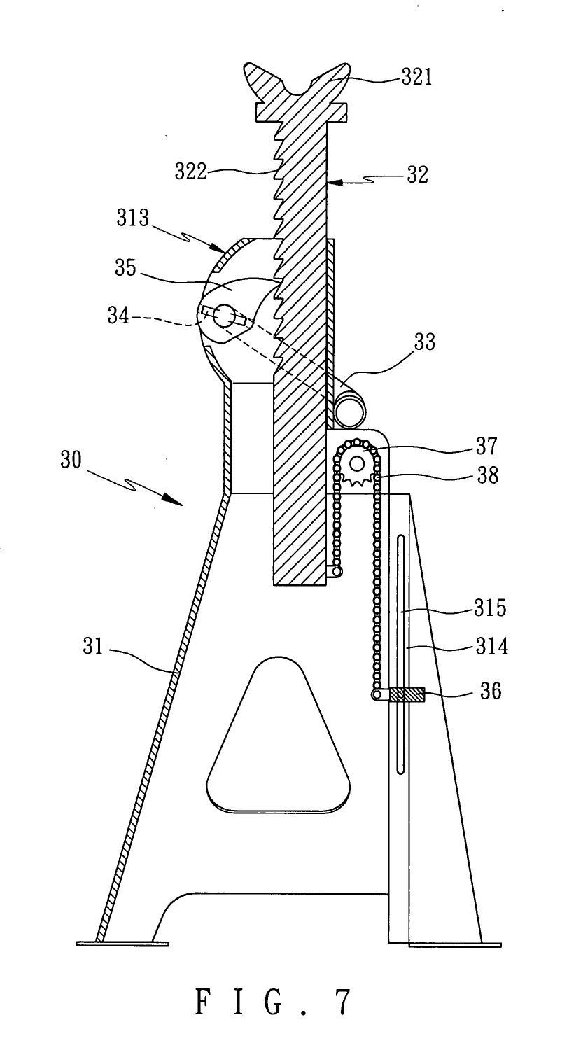

Referring to FIGS. 5-7, a support device 30 in accordance with the present invention comprises a base 31 constructed in the form of a pyramid, and including pads 311 provided on the bottom thereof for abutting against the ground, a receiving portion 313 disposed on the top of one side thereof and having a retaining recess 312 formed therethrough for receiving a post 32. The post 32 includes a holding segment 321 mounted on the top thereof for holding a heavy object, and between the post 32 and the base 31 is defined with a stopping mechanism including teeth 322 arranged on one side of the post 32. The receiving portion 313 of the base 31 includes a rotatable lever 33 axially affixed therein and having an engaging member 35 attached thereon by using a bolt element 34 for engaging with the teeth 322, such that as rotating the lever 33, the engaging member 35 is actuated to rotate for controlling the open/close of the stopping mechanism, wherein the base 31 also includes two elongated plates 314 fixed on another side thereof respectively, and each having a longitudinal guide slot 315 formed thereon, and includes a pedal 36 fitted in the longitudinal guide slots 315 thereof by way of a shaft 361 which is extendedly inserted in the pedal 36 so that the pedal 36 permits to move upward and downward along the guide slots 315. Besides, between the pedal 36 and the post 32 is defined with a transmitting mechanism including a rotatable wheel 37 pivotally disposed on the base 31 and having a chain 38, one end of which is coupled to the bottom of the post 32, and another end of which is connected to the pedal 36, mounted thereon, hence while the pedal 36 moves vertically, the post 32 is urged to move vertically as well by using the chain 38 and the rotatable wheel 37.

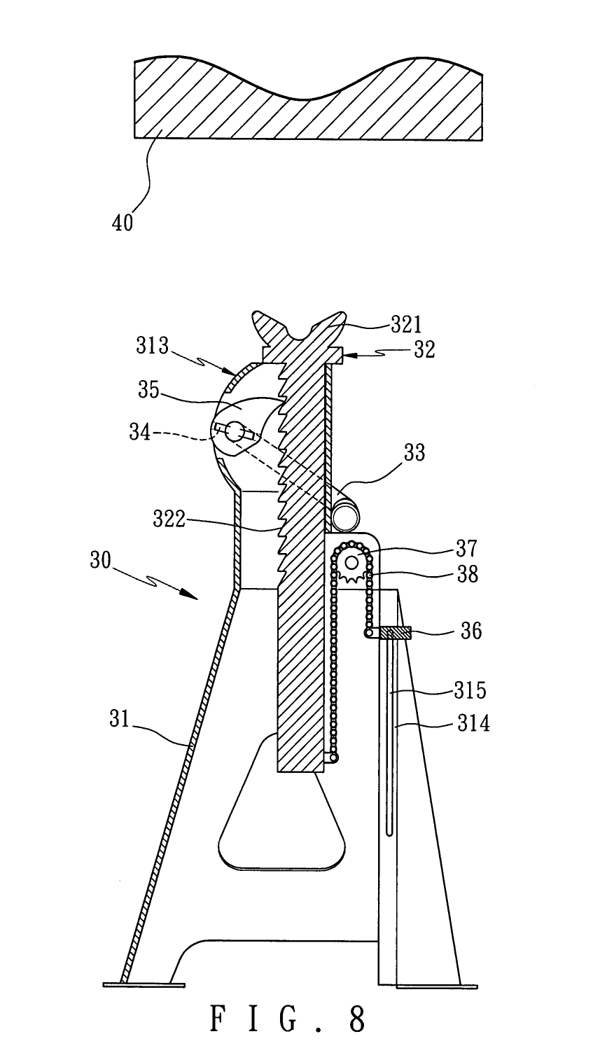

In operation of lifting a heavy object, as illustrated in FIG. 8, a lifter such as a jack or a lift (not shown), is used to raise a heavy object 40 up to a proper height, and then the support device 30 of the present invention is placed beneath the heavy object 40.

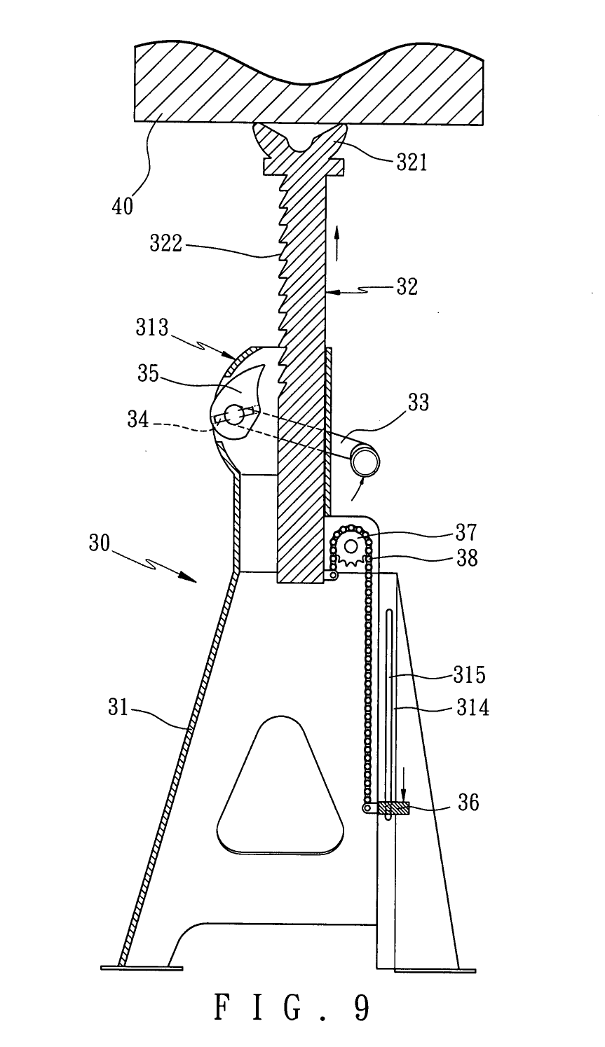

With reference to FIG. 9, as further pushing the lever 33 upward, the engaging member 35 is driven to rotate upwardly for disengaging from the teeth 322 of the post 32, thus opening the stopping mechanism; in the meantime, the user may step the pedal 36 downwardly in a labor saving manner, and by means of the chain 38 and the rotatable wheel 37, the post 32 is actuated to quickly move upward so as to contact with the heavy object 40.

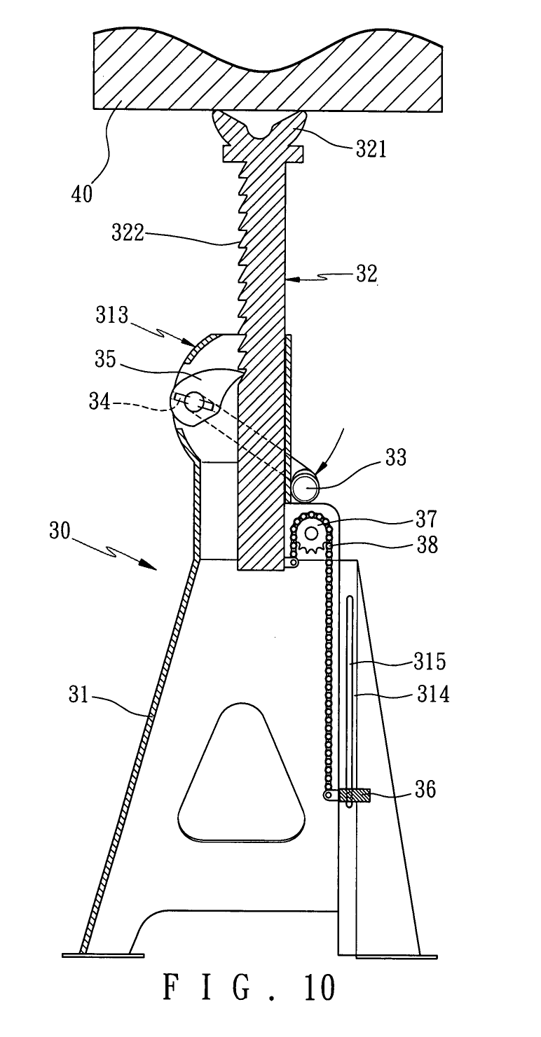

As shown in FIG. 10, after the support 32 contacts with the bottom of the heavy object 40, the lever 33 is pulled downwardly to urge the downward rotation of the engaging member 35 and the engagement of the engaging member 35 with the teeth 322 of the post 32 so as to close the stopping mechanism, therefore the post 32 is positioned at a proper height and the lifer is removed then. Simultaneously, since the heavy object 40 presses the post 32 and transmits to the lever 33 through the teeth 322 and the engaging member 35, and the end portion of the lever 33 biases against the base 31, the engaging member 35 is effectively positioned and matingly engaged with the teeth 322 of the post 32.

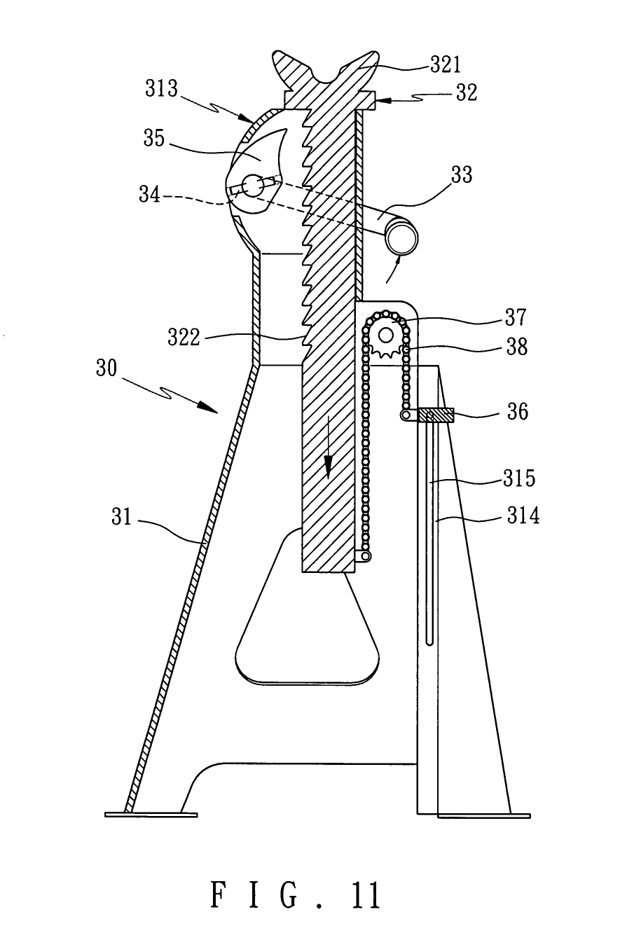

Referring to FIG. 11, behind the maintenance process of the heavy object, the lifter is utilized to raise the heavy object once more and then removed for the storage; meanwhile, the lever 33 is pushed upwardly to actuate the upward rotation of the engaging member 35, and then the engaging member 35 disengages from the teeth 322 of the post 32, thus opening the stopping mechanism.

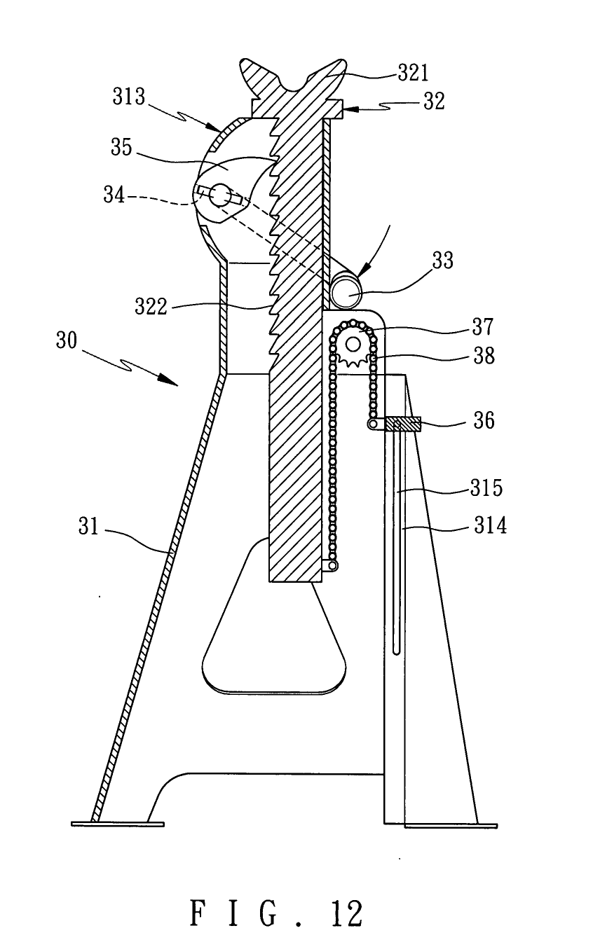

As illustrated in FIG. 12, after opening the stopping mechanism, due to the post 32 is not engaged with the engaging member 35, the post 32 automatically descends by using its weight so as to retract to an appropriate height. Thereafter, the user may pull the lever 33 downwardly so as to engage the engaging member 35 with the teeth 322 of the post 32 and to close the stopping mechanism, thereby positioning the post 32 at a proper storing height.

The invention is not limited to the above embodiment but various modifications thereof may be made. It will be understood by those skilled in the art that various changes in form and detail may made without departing from the scope and spirit of the present invention.

What is claimed is:

1. A support device comprising:
a base including a receiving portion disposed on the top of one side thereof and having a retaining recess formed therethrough, and including a pedal fitted on another side thereof for a vertical movement;
a post received in said receiving portion of said base and including a holding segment mounted on the top thereof for holding a heavy object,
a stopping mechanism defined between said post and said base for positioning said post at a proper height;
a transmitting mechanism defined between said pedal of said base and said post so that said pedal allows to actuate the vertical movement of said post.

2. The support device as claimed in claim 1, wherein said base includes pads provided on the bottom thereof for abutting against the ground.

3. The support device as claimed in claim 1, wherein said stopping mechanism includes teeth arranged on one side of said post, and said receiving portion of said base includes a rotatable lever axially affixed therein and having an engaging member attached thereon for engaging with said teeth of said post.

4. The support device as claimed in claim 3, wherein said retaining member is attached on said rotatable lever by way of a bolt element so that said rotatable lever allows to be rotated.

5. The support device as claimed in claim 3, wherein as said engaging member engages with said teeth of said post, the end portion of said lever biases against said base so that said engaging member is positioned effectively.

6. The support device as claimed in claim 1, wherein said base also includes two elongated plates fixed on another side thereof respectively, and each having a longitudinal guide slot formed thereon, and includes a pedal fitted in said longitudinal guide slots thereof by way of a shaft which is extendedly inserted in said pedal so that said pedal permits to move upward and downward along said guide slots.

7. The support device as claimed in claim 1, wherein a transmitting mechanism includes a rotatable wheel pivotally disposed on said base and having a chain, one end of which is coupled to the bottom of said post, and another end of which is connected to said pedal, mounted thereon, hence said pedal may actuate the vertical movement of said post.
